(19) United States
(12) Patent Application Publication
(10) Pub. No.: US 2025/0240156 A1
(43) Pub. Date: Jul. 24, 2025

(54) SYSTEMS AND METHODS RELATING TO CONFIDENTIAL COMPUTING KEY MIXING HAZARD MANAGEMENT

(71) Applicant: Advanced Micro Devices, Inc., Santa Clara, CA (US)

(72) Inventors: Amit P. Apte, Austin, TX (US); Eric Christopher Morton, Austin, TX (US); David Kaplan, Austin, TX (US)

(73) Assignee: Advanced Micro Devices, Inc., Santa Clara, CA (US)

(21) Appl. No.: 18/087,919

(22) Filed: Dec. 23, 2022

(51) Int. Cl. H04L 9/08; G06F 12/0811; G06F 12/0815; G06F 12/0891; H04L 9/14

(52) U.S. Cl. CPC H04L 9/088; G06F 12/0811; G06F 12/0815; G06F 12/0891; H04L 9/14; G06F 2212/1052

(57) ABSTRACT

A disclosed method can include (i) detecting, by a probe filter in a coherent fabric interconnect, an access request to a specific memory address of a cache hierarchy using a new encryption key, (ii) verifying, by the probe filter, that the specific memory address stores data encrypted using a previous and distinct encryption key, and (iii) evicting, by the probe filter in response to the verifying, references to the previous and distinct encryption key from the cache hierarchy. Various other methods, systems, and computer-readable media are also disclosed.

### BACKGROUND

Modern computer chip manufacturers can provide confidential computing functionality, which can enable customers to purchase virtual computing power while nevertheless trusting that underlying data is not being exposed to a vendor providing the virtual computing power. To achieve confidential computing functionality, these modern computer chip manufacturers can provide sophisticated subsystems for encrypting and decrypting data. As discussed further below, this application discloses problems and solutions related to the usage of encrypting and decrypting data to provide confidential computing functionality.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an example computing system.

FIG. 2 is a block diagram of an example core complex.

FIG. 3 is a block diagram of an example multi-CPU system.

FIG. 4 is a block diagram of an example cache directory.

FIG. 5 is a flow diagram for an example method relating to confidential computing key mixing hazard management.

FIG. 6 is a block diagram illustrating an example assignment of encryption keys to different memory locations.

FIG. 7 is another block diagram illustrating an example eviction of a reference to a previously used encryption key.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to addressing and managing hazards that can arise due to the mixing of encryption keys within a confidential computing environment. In other words, a modern confidential computing configuration can involve assigning particular keys to particular memory locations, such that data stored at those particular locations is encrypted by the corresponding key. Moreover, access to particular keys can be strictly compartmentalized such that entities lacking the corresponding key to a memory location are prevented from having any visibility into the underlying data content there. As discussed in more detail below, in some scenarios a hazard can arise whereby a write operation attempts to store new data to a specific memory location without first evicting stale data that was stored using a different encryption key, thereby creating a threat to data coherence and a corresponding threat to data integrity. To address these threats to data coherence and data integrity, this application discloses a key mixing hazard management system that effectively embeds a probe filter with intelligence regarding which encryption keys have been used at which specific memory locations within a cache hierarchy. Accordingly, the probe filter can detect when a write operation threatens to undermine data coherence and data integrity due to the presence of stale data recorded using a different encryption key, and the probe filter can responsively evict the stale data and/or corresponding references to the different encryption key.

By way of background, confidential computing is a security paradigm that seeks to protect the confidentiality of a workload from higher level code within a computing system. The case of cloud computing helps to illustrate the concept of confidential computing. For example, a customer might seek to perform a workload through a cloud computing vendor, and yet nevertheless the customer might also seek to prevent the vendor itself from decrypting the corresponding data or otherwise gaining visibility into the workload itself. This is the problem that confidential computing is designed to address and to solve. In the example outlined above, successful usage of confidential computing would prevent the vendor from having visibility into the workload and corresponding data. In the case of sensitive data, such as medical information or financial information, the successful implementation of confidential computing can beneficially protect the privacy of this information.

Confidential computing can be implemented by manufacturers at the hardware level within server chips, for example. In these cases, a particular confidential computing configuration can provide both hardware isolation and encryption for corresponding workloads. Accordingly, the implementation of confidential computing can provide assurances to customers that each respective workload can be assigned a corresponding encryption key to encrypt the underlying data. Moreover, in these configurations the customer can be assured that the corresponding vendor does not have access to the specific keys used to encrypt workloads.

Moreover, confidential computing also enables the vendor itself to advertise the ability to protect the confidentiality of customer data. Accordingly, the vendor can market to customers that it is using particular server chips with the capability for confidential computing and, furthermore, the vendor can advertise that it has turned this confidential computing feature on. The customers can verify this latter statement themselves using a feature such as attestation.

In some examples, the enablement of confidential computing can feature data use and protection functionality, as discussed further below. In particular, the enablement of confidential computing can result in workload data being encrypted in memory (e.g., DRAM) using an encryption key assigned to a particular virtual machine. In some examples, the encryption key can correspond to a symmetrical cipher. In other examples, an asymmetrical cipher can be used. In further examples, the confidential computing system can be configured such that it understands whether it is currently processing data for one virtual machine, or for a different and distinct customer's workload, or instead processing for the hypervisor, etc. Accordingly, confidential computing can be enabled through a hardware configuration that prevents access to a particular encryption key by entities other than the particular customer having permission.

Within a confidential computing environment, data structures can be configured to implement access control. For example, these data structures can ensure that one entity cannot corrupt data (e.g., a page of memory) that belongs to another and distinct entity (e.g., one customer cannot corrupt another customer's data). As another illustrative example, a computing subcomponent such as a hypervisor might not be considered trusted, from the perspective of the customer, because the hypervisor contents might be accessible to the vendor. Accordingly, the implementation of confidential computing can enable the customer to nevertheless trust that the hypervisor and/or vendor will not gain access to the underlying data for a corresponding workload due to hardware constraints preventing access to the appropriate encryption key. For example, if a customer was assigned a particular page of memory through a guest virtual machine, the customer could nevertheless trust through confidential computing that the hypervisor cannot access this particular page of memory.

One of the beneficial features of a confidential computing configuration is the guarantee of data integrity. Data integrity refers to an assurance that, for example, when a guest virtual machine writes to a particular memory location, then when the guest virtual machine later attempts to retrieve the corresponding data from that location, the data will have remained accurate and unchanged. A confidential computing configuration can help achieve data integrity by preventing the data from being corrupted or replayed prior to a subsequent memory access. In alternative configurations, an assurance can be provided that, even if data is overwritten at a particular memory location, then this is relatively benign, because the data is assured to be encrypted, but other configurations that preserve data integrity can have advantages over these alternative configurations. In other words, and generally speaking, a confidential computing configuration can provide an assurance that, when data has been stored at a specific location assigned to a particular entity according to recorded access rights, then only that particular entity could have been physically enabled through hardware to have actually written that data to that particular location. Thus, if an entity lacking permission according to the access rights attempts to write data to a particular memory location, then this write operation will be blocked at a hardware level.

In some examples, a method can include (i) detecting, by a probe filter, an access request to a specific memory address using a first encryption key, (ii) verifying, by the probe filter, that the specific memory address stores stale data encrypted using a second encryption key, and (iii) evicting, by the probe filter in response to the verifying, references to the previous and distinct encryption key.

In some examples, data is stored within the cache hierarchy in an unencrypted state by decrypting the data prior to storage.

In some examples, the probe filter implements a table to track which encryption keys are assigned to which specific memory addresses.

In some examples, encrypting or decrypting an item of data is performed by a memory controller.

In some examples, evicting references to the second encryption key maintains either data coherence or data integrity.

In some examples, the cache directory is configured such that an attempt to access the specific memory address using an encryption key not currently associated with the specific memory address results in a cache miss.

In further examples, the cache directory is configured such that an attempt to access the specific memory address using an encryption key not currently associated with the specific memory address results in a cache miss without detection of a failed write operation.

In some examples, usage of the first encryption key and the second encryption key facilitates achievement of confidential computing with respect to the coherent fabric interconnect.

In some examples, evicting references to the second encryption key from the cache hierarchy is performed by issuing an invalidating probe.

In further examples, the invalidating probe invalidates all references to the second encryption key within the cache hierarchy.

An example probe filter can include a (i) detector that detects, within in a coherent fabric interconnect, an access request to a specific memory address of a cache hierarchy using a new encryption key, (ii) an access rights table that maps memory locations to encryption keys, a (iii) verifier that verifies, by referencing the access rights table, that the specific memory address stores stale data encrypted using a stale encryption key, and (iv) an evictor that evicts, in response to the verifying, references to the stale encryption key from the cache hierarchy. In some examples, the probe filter can be implemented on a computer chip.

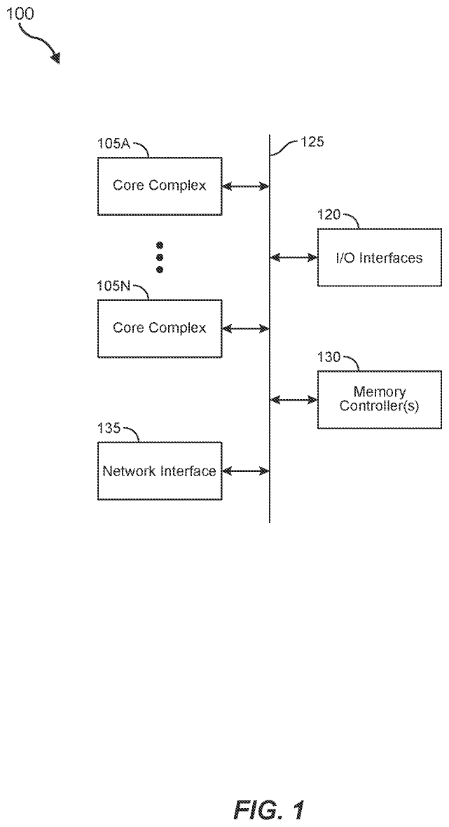

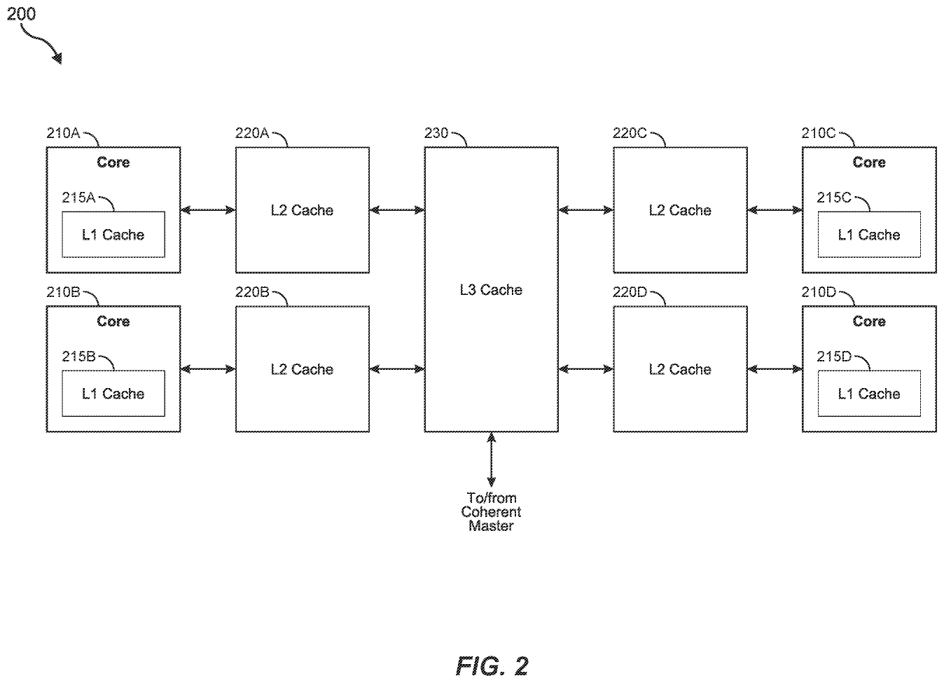

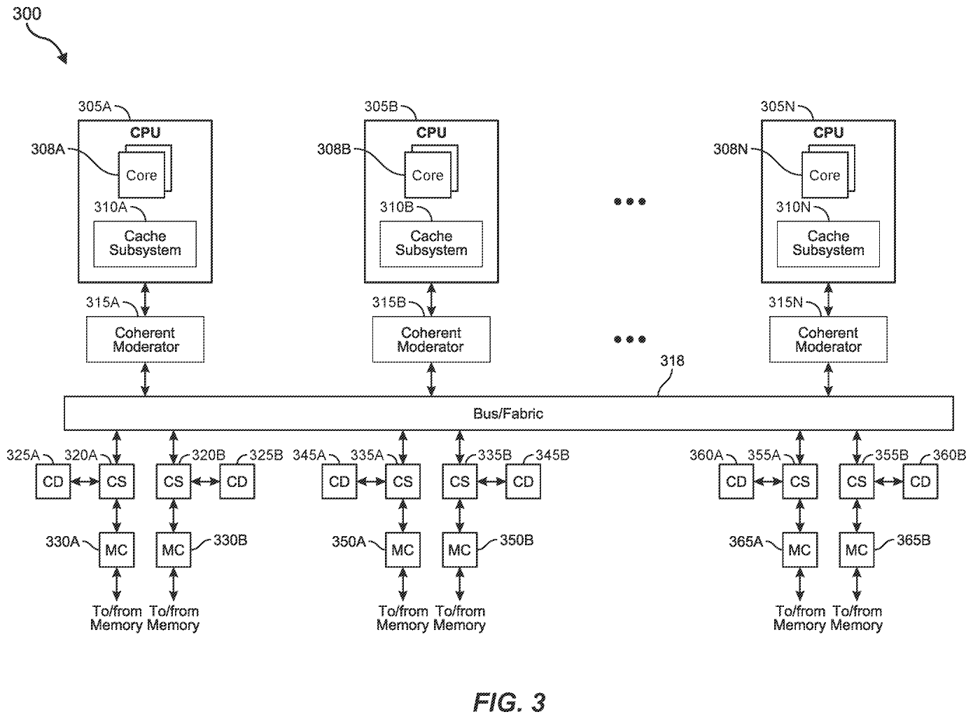

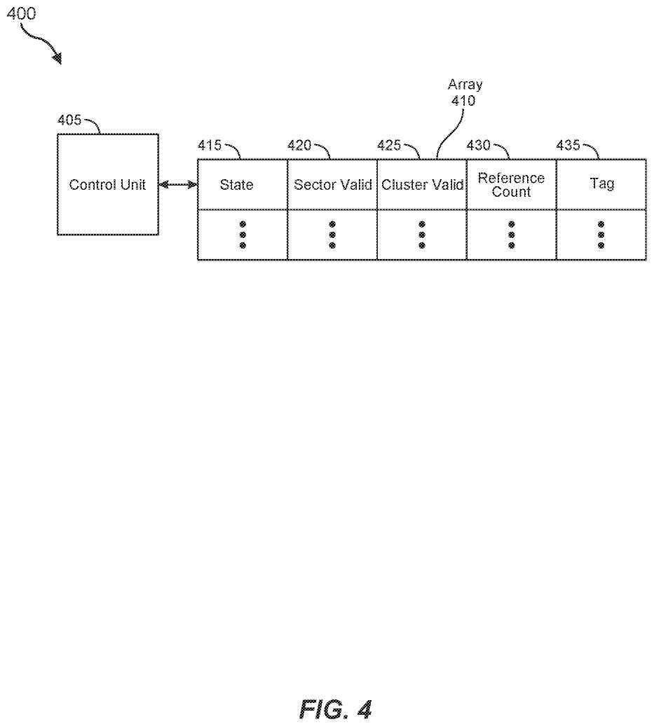

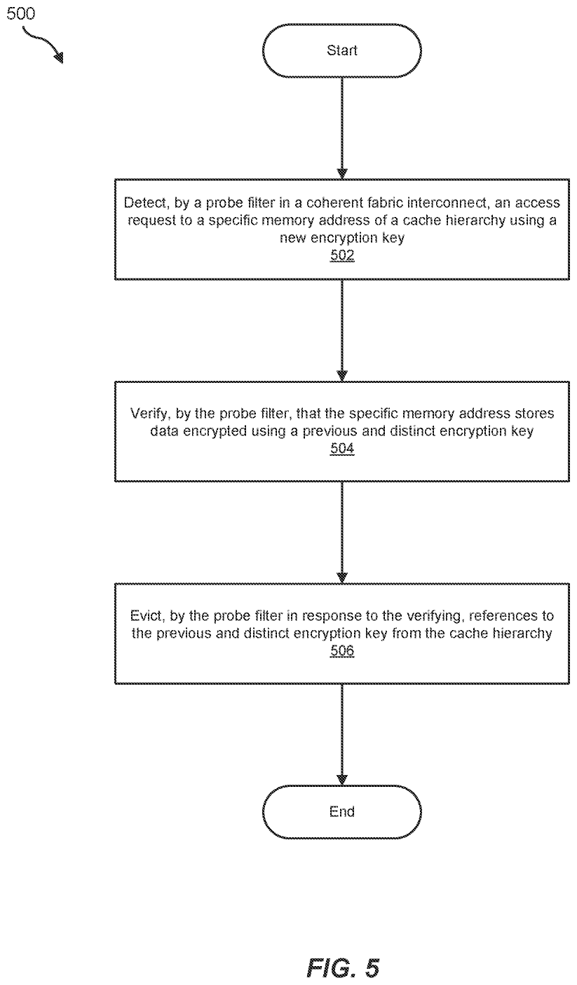

This application generally discloses an inventive method (see FIG. 5) to be performed by a probe filter in the context of the coherence fabric of a computing core system. Accordingly, FIGS. 1-4 provide background discussions of the technological environment in which the method of FIG. 5 can be performed. FIG. 1 focuses on a computing system, FIG. 2 focuses on a core complex, FIG. 3 focuses on a multi-CPU system, and FIG. 4 focuses on an example cache directory.

Referring now to FIG. 1, a block diagram of one implementation of a computing system 100 is shown. In one implementation, computing system 100 includes at least core complexes 105A-N, input/output (I/O) interfaces 120, bus 125, memory controller(s) 130, and network interface 135. In other implementations, computing system 100 can include other components and/or computing system 100 can be arranged differently. In one implementation, each core complex 105A-N includes one or more general purpose processors, such as central processing units (CPUs). It is noted that a “core complex” can also be referred to as a “processing node” or a “CPU” herein. In some implementations, one or more core complexes 105A-N can include a data parallel processor with a highly parallel architecture. Examples of data parallel processors include graphics processing units (GPUs), digital signal processors (DSPs), field programmable gate arrays (FPGAs), application specific integrated circuits (ASICs), and so forth. Each processor core within core complex 105A-N includes a cache subsystem with one or more levels of caches. In one implementation, each core complex 105A-N includes a cache (e.g., level three (L3) cache) which is shared between multiple processor cores.

Memory controller(s) 130 are representative of any number and type of memory controllers accessible by core complexes 105A-N. Memory controller(s) 130 are coupled to any number and type of memory devices (not shown). For example, the type of memory in memory device(s) coupled to memory controller(s) 130 can include Dynamic Random Access Memory (DRAM), Static Random Access Memory (SRAM), NAND Flash memory, NOR flash memory, Ferroelectric Random Access Memory (FeRAM), or others. I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices can be coupled to I/O interfaces 120. Such peripheral devices include (but are not limited to) displays, keyboards, mice, printers, scanners, joysticks or other types of game controllers, media recording devices, external storage devices, network interface cards, and so forth.

In various implementations, computing system 100 can be a server, computer, laptop, mobile device, game console, streaming device, wearable device, or any of various other types of computing systems or devices. It is noted that the number of components of computing system 100 can vary from implementation to implementation. There can be more or fewer of each component than the number shown in FIG. 1. It is also noted that computing system 100 can include other components not shown in FIG. 1. Additionally, in other implementations, computing system 100 can be structured in other ways than shown in FIG. 1.

Turning now to FIG. 2, a block diagram of one implementation of a core complex 200 is shown. In one implementation, core complex 200 includes four processor cores 210A-D. In other implementations, core complex 200 can include other numbers of processor cores. It is noted that a “core complex” can also be referred to as a “processing node” or “CPU” herein. In one implementation, the components of core complex 200 are included within core complexes 105A-N (of FIG. 1).

Each processor core 210A-D includes a cache subsystem for storing data and instructions retrieved from the memory subsystem (not shown). For example, in one implementation, each core 210A-D includes a corresponding level one (L1) cache 215A-D.

Each processor core 210A-D can include or be coupled to a corresponding level two (L2) cache 220A-D. Additionally, in one implementation, core complex 200 includes a level three (L3) cache 230 which is shared by the processor cores 210A-D. L3 cache 230 is coupled to a coherent moderator for access to the fabric and memory subsystem. It is noted that in other implementations, core complex 200 can include other types of cache subsystems with other numbers of caches and/or with other configurations of the different cache levels.

Referring now to FIG. 3, a block diagram of one implementation of a multi-CPU system 300 is shown. In one implementation, system includes multiple CPUs 305A-N. The number of CPUs per system can vary from implementation to implementation. Each CPU 305A-N can include any number of cores 308A-N, respectively, with the number of cores varying according to the implementation. Each CPU 305A-N also includes a corresponding cache subsystem 310A-N. Each cache subsystem 310A-N can include any number of levels of caches and any type of cache hierarchy structure.

In one implementation, each CPU 305A-N is connected to a corresponding coherent moderator 315A-N. As used herein, a “coherent moderator” is defined as an agent that processes traffic flowing over an interconnect (e.g., bus/fabric 318) and manages coherency for a connected CPU. To manage coherency, a coherent moderator receives and processes coherency-related messages and probes, and the coherent moderator generates coherency-related requests and probes. It is noted that a “coherent moderator” can also be referred to as a “coherent moderator unit” herein.

In one implementation, each CPU 305A-N is coupled to a pair of coherent stations via a corresponding coherent moderator 315A-N and bus/fabric 318. For example, CPU 305A is coupled through coherent moderator 315A and bus/fabric 318 to coherent stations 320A-B. Coherent station (CS) 320A is coupled to memory controller (MC) 330A and coherent station 320B is coupled to memory controller 330B. Coherent station 320A is coupled to cache directory (CD) 325A, with cache directory 325A including entries for memory regions that have cache lines cached in system 300 for the memory accessible through memory controller 330A. It is noted that cache directory 325A, and each of the other cache directories, can also be referred to as a “probe filter”. Similarly, coherent station 320B is coupled to cache directory 325B, with cache directory 325B including entries for memory regions that have cache lines cached in system 300 for the memory accessible through memory controller 330B. It is noted that the example of having two memory controllers per CPU is merely indicative of one implementation. It should be understood that in other implementations, each CPU 305A-N can be connected to other numbers of memory controllers besides two.

In a similar configuration to that of CPU 305A, CPU 305B is coupled to coherent stations 335A-B via coherent moderator 315B and bus/fabric 318. Coherent station 335A is coupled to memory via memory controller 350A, and coherent station 335A is also coupled to cache directory 345A to manage the coherency of cache lines corresponding to memory accessible through memory controller 350A. Coherent station 335B is coupled to cache directory 345B and coherent station 335B is coupled to memory via memory controller 365B. Also, CPU 305N is coupled to coherent stations 355A-B via coherent moderator 315N and bus/fabric 318. Coherent stations 355A-B are coupled to cache directory 360A-B, respectively, and coherent stations 355A-B are coupled to memory via memory controllers 365A-B, respectively. As used herein, a “coherent station” is defined as an agent that manages coherency by processing received requests and probes that target a corresponding memory controller. It is noted that a “coherent station” can also be referred to as a “coherent station unit” herein. Additionally, as used herein, a “probe” is defined as a message passed from a coherency point to one or more caches in the computer system to determine if the caches have a copy of a block of data and optionally to indicate the state into which the cache should place the block of data.

When a coherent station receives a memory request targeting its corresponding memory controller, the coherent station performs a lookup to its corresponding cache directory to determine if the request targets a region which has at least one cache line cached in any of the cache subsystems. In one implementation, each cache directory in system 300 tracks regions of memory, wherein a region includes a plurality of cache lines. The size of the region being tracked can vary from implementation to implementation. By tracking at a granularity of a region rather than at a finer granularity of a cache line, the size of each cache directory is reduced. It is noted that a “region” can also be referred to as a “page” herein. When a request is received by a coherent station, the coherent station determines the region which is targeted by the request. Then a lookup is performed of the cache directory for this region. If the lookup results in a hit, then the coherent station sends a probe to the CPU(s) which are identified in the hit entry. The type of probe that is generated by the coherent station depends on the coherency state specified by the hit entry.

Although not shown in FIG. 3, in other implementations there can be other connections from bus/fabric 318 to other components not shown to avoid obscuring the figure. For example, in another implementation, bus/fabric 318 includes connections to one or more I/O interfaces and one or more I/O devices.

Turning now to FIG. 4, a block diagram of one implementation of a cache directory 400 is shown. In one implementation, cache directory 400 includes control unit 405 and array 410. Array 410 can include any number of entries, with the number of entries varying according to the implementation. In one implementation, each entry of array 410 includes a state field 415, sector valid field 420, cluster valid field 425, reference count field 430, and tag field 435. In other implementations, the entries of array 410 can include other fields and/or can be arranged in other suitable manners.

The state field 415 includes state bits that specify the aggregate state of the region. The aggregate state is a reflection of the most restrictive cache line state for this particular region. For example, the state for a given region is stored as “dirty” even if only a single cache line for the entire given region is dirty. Also, the state for a given region is stored as “shared” even if only a single cache line of the entire given region is shared.

The sector valid field 420 stores a bit vector corresponding to sub-groups or sectors of lines within the region to provide fine grained tracking. By tracking sub-groups of lines within the region, the number of unwanted regular coherency probes and individual line probes generated while unrolling a region invalidation probe can be reduced. As used herein, a “region invalidation probe” is defined as a probe generated by the cache directory in response to a region entry being evicted from the cache directory. When a coherent moderator receives a region invalidation probe, the coherent moderator invalidates each cache line of the region that is cached by the local CPU. Additionally, tracker and sector valid bits are included in the region invalidate probes to reduce probe amplification at the CPU caches.

The organization of sub-groups and the number of bits in sector valid field 420 can vary according to the implementation. In one implementation, two lines are tracked within a particular region entry using sector valid field 420. In another implementation, other numbers of lines can be tracked within each region entry. In this implementation, sector valid field 420 can be used to indicate the number of partitions that are being individually tracked within the region. Additionally, the partitions can be identified using offsets which are stored in sector valid field 420. Each offset identifies the location of the given partition within the given region. Sector valid field 420, or another field of the entry, can also indicate separate owners and separate states for each partition within the given region.

The cluster valid field 425 includes a bit vector to track the presence of the region across various CPU cache clusters. For example, in one implementation, CPUs are grouped together into clusters of CPUs. The bit vector stored in cluster valid field 425 is used to reduce probe destinations for regular coherency probes and region invalidation probes.

The reference count field 430 is used to track the number of cache lines of the region which are cached somewhere in the system. On the first access to a region, an entry is installed in table 410 and the reference count field 430 is set to one. Over time, each time a cache accesses a cache line from this region, the reference count is incremented. As cache lines from this region get evicted by the caches, the reference count decrements. Eventually, if the reference count reaches zero, the entry is marked as invalid and the entry can be reused for another region. By utilizing the reference count field 430, the incidence of region invalidate probes can be reduced. The reference count filed 430 allows directory entries to be reclaimed when an entry is associated with a region with no active subscribers. In one implementation, the reference count field 430 can saturate once the reference count crosses a threshold. The threshold can be set to a value large enough to handle private access patterns while sacrificing some accuracy when handling widely shared access patterns for communication data. The tag field 435 includes the tag bits that are used to identify the entry associated with a particular region.

With the above discussion of FIGS. 1-4 as providing an overview of the technological background for this application, FIG. 5 shows an example flow diagram for a method 500, which can address and remediate the confidential computing key mixing hazard outlined at length above. At step 502, one or more of the systems described herein can detect an access request to a specific memory address of a cache hierarchy using a new encryption key. For example, “probe filter” or cache directory 325A of FIG. 3 can perform step 502. Additionally, or alternatively, any other suitable component of FIGS. 1-4 and/or any other suitable component within a coherent fabric interconnect can perform step 502.

As used herein, the term “coherent fabric interconnect” can refer to a computing hardware component that facilitates data coherency while connecting multiple different subcomponents or multiple different cores in a computing system. As used herein, the term “cache hierarchy” can refer to a hierarchy or directory of at least two layers of caches. Furthermore, as used herein, the term “new encryption key” can refer simply to an encryption key that is attempted to be used after the previous usage of the distinct encryption key at step 504, as discussed in more detail below. Similarly, as used herein, the term “probe filter” can refer to a fabric subcomponent that facilitates probe, snoop, and/or other fabric communication.

A brief overview of probe filters or snoop filters can be helpful in the context of FIG. 5. With respect to large multiprocessor cache systems, which can effectively extend and interconnect subcomponents across multiple sockets, there can be multiple cache hierarchies attempting to access addresses in memory. In order to maintain cache coherency, a brute force method would involve, in response to receiving an access request, sending out a broadcast probe to all of the caches in the system to determine whether any of these caches has a more recent copy of a corresponding line of data (i.e., more recent than in memory). Nevertheless, a dilemma can arise in the context of larger systems involving multiple sockets and multiple cache hierarchies, whereby the number of probes, snoops, etc., becomes exponentially larger and increasingly impractical or intractable.

In particular, probe filters can function by determining, in response to an access request, whether a probe should be sent (i.e., because a particular line might not have been accessed by any CPU cache in the overall system). Moreover, if a probe should be sent, the probe filters can also attempt to reduce the number of probes being sent. For example, the probe filters can determine that a probe does not need to be sent to a cache location where the corresponding data could not have been stored, such that the hypothetical probe would be a wasteful probe. On the other hand, the probe filter can determine that a different cache location might store the data that is sought after, and therefore the probe filter can issue an appropriate probe in response.

FIG. 5 can address the hazard of encryption key mixing in the context of a confidential computing configuration, as outlined above. Generally speaking, within such a confidential computing configuration, data can be allocated and the allocated from between different entities on a rolling basis. By way of illustrative example, at first a page of memory can be allocated to a hypervisor and used by the hypervisor accordingly. After completing a particular task or workload, the hypervisor might indicate that the hypervisor no longer needs or requests the particular allocated page of memory. Instead, the hypervisor can seek to instantiate a new guest virtual machine. Moreover, in this example, the hypervisor can reallocate the page of memory to the newly instantiated guest virtual machine. Upon taking possession or allocation of the page of memory, the guest virtual machine might then enjoy the assurance of confidentiality provided by confidential computing.

Continuing with the example outlined above, after the new guest virtual machine takes possession of the page of memory, the guest virtual machine might not have any information or understanding of what the contents of the page of memory are, or what the contents were previously used for. On the other hand, the new guest virtual machine will seek to start writing or overwriting data to the page of memory. According to a confidential computing configuration, steps can be taken (see FIG. 5) to ensure the preservation of data coherency as well as the preservation of data integrity.

From a high level of generality, a confidential computing configuration can, in some examples, maintain data in an unencrypted state when the data is stored within the cache hierarchy. In these examples, the encryption and/or decryption of data can be performed at the level of the memory controller, while maintaining data within the cache hierarchy unencrypted or decrypted. In some scenarios, certain items of data might linger within a corresponding memory location of the cache hierarchy for a relatively long period of time.

Returning to the example of the new guest virtual machine, when that new guest virtual machine takes possession of the page of memory, the new guest virtual machine will start writing to the page of memory using its own encryption key. This can introduce a dilemma addressed and solved by the methodology of FIG. 5: a particular item of data might have been cached earlier at the same location using a different key. In other words, a cache hierarchy can store information indicating which particular encryption key was used to store which particular item of data. The dilemma arises when a write operation attempts to perform writing data using an incorrect encryption key according to the recorded access rights. In that situation, certain confidential computing configurations might simply record the attempted write operation as a cache miss, without there arising awareness at the CPU level of this event (this feature of such confidential computing configurations might have been adopted as an explicit design decision to simplify management of the cache hierarchy, for example). In other words, certain confidential computing configurations might not be able to initially detect when a new write operation is using a different encryption key at a particular memory location storing data encrypted using a previous and distinct key.

A brief overview helps to explain why the usage of the new encryption key might not be initially detected at the CPU level. In certain confidential computing configurations, the particular key used to encrypt data is simply treated as an extension of the memory address itself. By way of illustrative example, a memory address might have 36 bits, and an additional 10 bits could be appended to this memory address as the encryption key. The CPU in certain confidential computing configurations might simply treat the resulting 46 bits as a single memory address. Accordingly, the CPU in these scenarios might have no awareness that the appended bits correspond to an encryption key or encryption key ID.

Due to this design constraint, scenarios can arise where, in the CPU, there is an older copy of data at a particular memory location stored using a first encryption key. Subsequently, if the memory location is not manually flushed, then the attempt to perform a write operation at that memory location using a second and distinct encryption key could compromise data coherency or data integrity. In other words, two different cache lines might exist within the CPU simultaneously, but then these can be evicted out of order (i.e., due to the design constraints outlined above), which would corrupt memory.

To elaborate, the problem in one related solution includes flushing an old key prior to handing over control to a new guest. Such a flush can take one of at least two forms. First, the flush can include a complete cache flush, but this is an expensive and cumbersome approach. Second, and alternatively, this flush can include a selective flush, yet in this case the CPU cache involves software routines and additional hardware logic to find and flush accesses with a specific key. In contrast, implementations of the solution of this application can be much more selective, while also eliminating a requirement for any software routines and while being relatively simpler to build.

In addition to the above, a potential access attempt with a new key might not even be intentional. For example, an aggressive hypervisor prefetch might present itself as attempting to access data with a different key. In such scenarios, one related solution involving the cache flush can further result in performance costs due to these spurious hypervisor accesses.

As further discussed above, the failure to appropriately detect the attempt to write data using an incorrect encryption key constitutes a threat to data coherency and/or a threat to data integrity. Returning to the example of the new guest virtual machine, when the guest attempts to write data to a particular memory location and subsequently concludes that it has actually successfully written the data, but the same data using the same encryption key has been written to another location within the cache hierarchy, then this creates another example threat to data coherency and/or a threat to data integrity. By way of illustrative example, the guest virtual machine might have concluded that it successfully wrote all zeros to a particular memory location, but nevertheless the hypervisor had previously written all ones to that particular memory location, it now can become possible that the ones get evicted to the cache after the guest has attempted the write operation, therefore changing the contents of the memory in a way that is unexpected.

To address the dilemma outlined above, method 500 of FIG. 5 reflects an inventive technique for ensuring that stale data is appropriately evicted and data coherence and data integrity are preserved. Thus, at step 502 the probe filter or other fabric subcomponent can detect the write operation that threatens to compromise data coherency and/or data integrity, as outlined above.

Returning to FIG. 5, at step 504, one or more of the systems described herein can verify that the specific memory address stores data encrypted using a previous and distinct encryption key. For example, probe filter or cache directory 325A can perform step 504. Additionally, or alternatively, any other suitable subcomponent of the coherent fabric interconnect can perform step 504.

Step 504 can be performed in a variety of ways. Generally speaking, the probe filter can perform step 504 at least in part by maintaining a table of access rights. In particular, the probe filter can maintain a table that maps memory locations to corresponding encryption keys. Accordingly, when the probe filter encounters a write operation the probe filter has the option to consult the table of access rights to verify the encryption key used to store data that is already stored in the specific memory address.

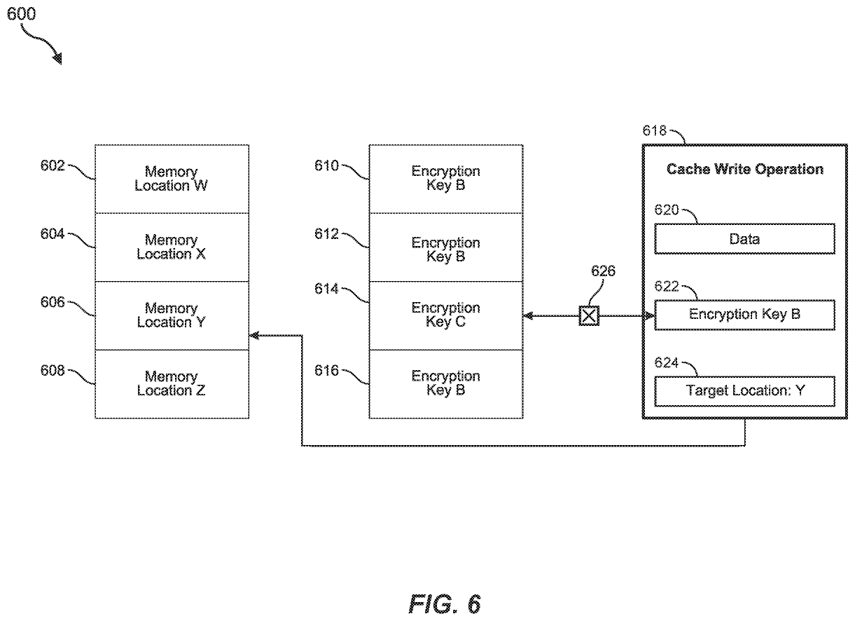

FIG. 6 shows an example workflow 600 that helps to illustrate the performance of method 500. By way of example, workflow 600 includes four different memory locations 602-608. Moreover, workflow 600 also indicates that four respective instances of encryption keys have been used and assigned to store data at those particular memory locations. For example, encryption key 610 has been used to store data at memory location 602, encryption key 612 has been used to store data at memory location 604, and so on.

Workflow 600 also further illustrates how the probe filter might detect a cache write operation 618, which can further involve data 620 to be written, the particular encryption key 622 for encrypting the data, and lastly a target location 624, which can specify a particular one of the four memory location shown in this figure. In this particular example, cache write operation 618 further specifies target location 624 that corresponds to memory location 606 (i.e., memory location “Y” in this figure). Nevertheless, as further shown in FIG. 6, cache write operation 618 also further specifies encryption key 622 (i.e., encryption key “B”), which does not match encryption key 614, which was previously used to store data at that particular location.

For instance, memory location 606 can include data (that was stored using encryption key “C” currently referenced in the corresponding table of access rights) that is now stale but has not been explicitly flushed. This creates an apparent threat to data coherency and/or data integrity, as indicated by an indicator 626 showing “X” as a mismatch between the two encryption keys.

In view of the above, before cache write operation 618 is actually attempted, which might threaten data coherence and data integrity for the reasons explained above, the methodology of FIG. 5 can be performed to evict the one or more references to the previous encryption key (i.e., key “C” in FIG. 6). Returning to FIG. 5, at step 506, one or more of the systems described herein can evict references to the previous and distinct encryption key from the cache hierarchy. For example, step 506 can be performed by the probe filter or cache directory 325A, as further discussed above, in response to the performance of step 504. As used herein, the phrase “evict” can refer to deleting, removing, or disabling encryption keys, or references to those encryption keys. The probe filter and/or cache directory 325A can, in some examples, evict the previous and distinct encryption key from the corresponding table of access rights.

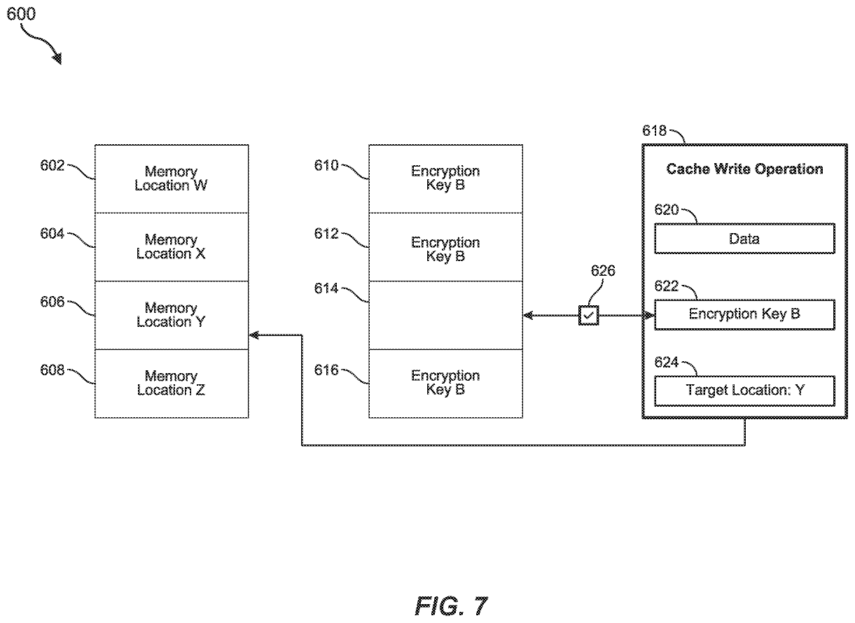

FIG. 7 shows an updated version of workflow 600 after the performance of step 506. As further illustrated in this figure, the probe filter or other fabric subcomponent has evicted encryption key 614 and/or one or more references to this encryption key. Accordingly, indicator 626 has changed to a checkmark further indicating that the key mixing hazard has been addressed and resolved, thereby helping to preserve data integrity and data coherence.

The probe filter or cache directory 325A can perform step 506 in a variety of ways. In one example, the probe filter can perform step 506 by issuing an invalidating probe. The invalidating probe can constitute a probe that invalidates, evicts, or revokes one or more references to an encryption key (e.g., the earlier used encryption key). For example, the invalidating probe might invalidate each and every reference to the earlier used encryption key within the entire cache hierarchy, or within one or more subcomponents of this hierarchy. Moreover, the eviction of the encryption key and the issuing of the invalidating probe can be performed entirely before the attempted write operation of step 502 is actually completed and before any memory is actually written using the new encryption key.

In this description, numerous specific details are set forth to provide a thorough understanding of the methods and mechanisms presented herein. However, one having ordinary skill in the art should recognize that the various implementations might be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements can be exaggerated relative to other elements.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
detecting, by a probe filter, an access request to a specific memory address using a first encryption key;
verifying, by the probe filter, that the specific memory address stores stale data encrypted using a second encryption key; and
evicting, by the probe filter in response to the verifying, references to the second encryption key.

2. The method of claim 1, wherein data is stored within a cache hierarchy in an unencrypted state by decrypting the data prior to storage.

3. The method of claim 1, wherein the probe filter implements a table to track which encryption keys are assigned to which specific memory addresses, and evicting references to the second encryption key includes evicting references to the second encryption key from the table.

4. The method of claim 1, wherein encrypting or decrypting an item of data is performed by a memory controller.

5. The method of claim 1, wherein evicting references to the second encryption key maintains either data coherence or data integrity.

6. The method of claim 1, wherein an attempt to access the specific memory address using an encryption key not currently associated with the specific memory address results in a cache miss.

7. The method of claim 6, wherein an attempt to access the specific memory address using an encryption key not currently associated with the specific memory address results in a cache miss without detection of a failed write operation.

8. The method of claim 1, wherein usage of the first encryption key and the second encryption key facilitates achievement of confidential computing.

9. The method of claim 1, wherein evicting references to the second encryption key is performed by issuing an invalidating probe.

10. The method of claim 9, wherein the invalidating probe invalidates all references to the second encryption key within the cache hierarchy.

11. A probe filter comprising:
a detector that detects, within a coherent fabric interconnect, an access request to a specific memory address of a cache hierarchy using a new encryption key;
an access rights table that maps memory locations to encryption keys;
a verifier that verifies, by referencing the access rights table, that the specific memory address stores stale data encrypted using a stale encryption key; and
an evictor that evicts, in response to the verifying, references to the stale encryption key from the cache hierarchy.

12. The probe filter of claim 11, wherein data is stored within the cache hierarchy in an unencrypted state.

13. The probe filter of claim 11, wherein the evictor is configured to evict references to the stale encryption key in the cache hierarchy by evicting all such references within the cache hierarchy.

14. The probe filter of claim 11, wherein the probe filter is coupled to a memory controller that performs encryption or decrypting of data for the specific memory address.

15. The probe filter of claim 11, wherein the probe filter being configured to evict references to the stale encryption key from the cache hierarchy maintains either data coherence or data integrity.

16. The probe filter of claim 11, wherein the cache hierarchy is configured such that an attempt to access the specific memory address using an encryption key not currently associated with the specific memory address results in a cache miss.

17. The probe filter of claim 16, wherein the cache hierarchy is configured such that an attempt to access the specific memory address using an encryption key not currently associated with the specific memory address results in a cache miss without detection of a failed write operation.

18. The probe filter of claim 11, wherein usage of the new encryption key and the stale encryption key facilitates achievement of confidential computing with respect to the coherent fabric interconnect.

19. The probe filter of claim 11, wherein the probe filter is configured to evict the references to the stale encryption key from the cache hierarchy at least in part by issuing an invalidating probe.

20. A computer chip comprising:
a detector that detects, within a coherent fabric interconnect, an access request to a specific memory address of a cache hierarchy using a new encryption key;
an access rights table that maps memory locations to encryption keys;
a verifier that verifies, by referencing the access rights table, that the specific memory address stores stale data encrypted using a stale encryption key; and
an evictor that evicts, in response to the verifying, references to the stale encryption key from the access rights table.
